(19) United States
(12) Patent Application Publication
(10) Pub. No.: US 2007/0051402 A1
(43) Pub. Date: Mar. 8, 2007

(54) Apparatus for collecting solar energy and method for making the same

(76) Inventors: Zhanxu Huang, Fremont, CA (US); Huimin Huang, Jiaxing (CN)

Correspondence Address: SILICON VALLEY PATENT AGENCY, 7394 WILDFLOWER WAY, CUPERTINO, CA, 95014, US

(21) Appl. No.: 11/252,281

(22) Filed: Oct. 17, 2005

(30) Foreign Application Priority Data
Sep. 2, 2005 (CN) 200520014597.1
Sep. 2, 2005 (CN) 200520014596.7

(51) Int. Cl. H02N 6/00

(52) U.S. Cl. 136/246

(57) ABSTRACT

Techniques for collecting a large amount of sunlight without overheating the underlying solar cells are disclosed. According to one aspect of the techniques, an array of concentrating lenses are provided, each of the lenses having a spherical surface that includes a plurality of concentric V-shaped rings. Such lenses have been proved to be able to focus a large amount of sunlight onto solar cells while at the same time reducing heat caused by the concentrated sunlight. To further heat dissipation, the solar cells are bonded to a metallic board. Various layouts of electrodes are designed to lead out the energy signals in the presence of the metallic board.

### BACKGROUND OF THE INVENTION

1. Field of the Invention

The present invention relates to the area of solar energy, and more particularly to solar energy apparatus based on solar cells and the method for the same, wherein the solar energy apparatus is used to generate electricity from solar energy.

2. The Background of Related Art

Solar cells are commonly used in solar energy power generators. Solar cells are made of special materials called semiconductors such as silicon. As commonly seen, there are arrays of solar cells mounted onto a board to become a solar panel in order to receive sufficient sunlight. An ordinary solar energy power generator needs a large area of solar cells, the cost of such solar energy power generator can be very high. To reduce the cost, some solar energy power generators are designed to have a large concentrating lens that focuses sunlight onto a limited area, thus reducing the amount of solar cells needed. Although a concentrating lens of a big diameter can gather a huge amount of sunlight, the problem of overheating the solar cells arises.

There is a great need for solutions that can gather sunlight efficiently while, at the same time, diffuse heat caused by the focused sunlight.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

Broadly speaking, the present invention pertains to solar energy apparatus based on solar cells and the method for the same, wherein the solar energy apparatus is used to generate electricity from solar energy. According to one aspect of the present invention, an array of concentrating lenses are provided, each of the lenses having a spherical surface that includes a plurality of concentric V-shaped rings. Such lenses have been proved to be able to focus a large amount of sunlight onto solar cells while at the same time reducing heat caused by the concentrated sunlight.

According to another aspect of the present invention, the solar cells are bonded to a metallic board to facilitate further heat dissipation. Various layouts of electrodes are designed to lead out the energy signals in the presence of the metallic board.

The present invention may be implemented in various forms. According to one embodiment, the present invention is an apparatus for collecting solar energy. The apparatus comprises an array of solar cells, and an array of concentrating lenses, each positioned above and focusing onto a group of cells, wherein each of the concentrating lenses has a spherical surface that includes a plurality of concentric V-shaped rings to reduce heat being brought to the group of cells.

One of the features, benefits and advantages is to provide efficient mechanisms that collect a large amount of sunlight and at the same time facilitate the dissipation of heat on the solar cells.

Other objects, features, benefits and advantages, together with the foregoing, are attained in the exercise of the invention in the following description and resulting in the embodiment illustrated in the accompanying drawings

### BRIEF DESCRIPTION OF THE DRAWINGS

These and other features, aspects, and advantages of the present invention will become better understood with regard to the following description, appended claims, and accompanying drawings where:

FIG. 1 shows a top-view of an array of concentrating lenses;

FIG. 2 shows a side view of the array of concentrating lenses;

FIG. 3 shows an exemplary embodiment of attaching solar cells to a substrate assisting heat dissipation;

FIG. 4 shows another exemplary embodiment of attaching solar cells to a substrate assisting heat dissipation; and

FIG. 5 shows still another exemplary embodiment of attaching solar cells to a substrate assisting heat dissipation.

### DETAILED DESCRIPTION OF THE PREFERRED EMBODIMENT

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

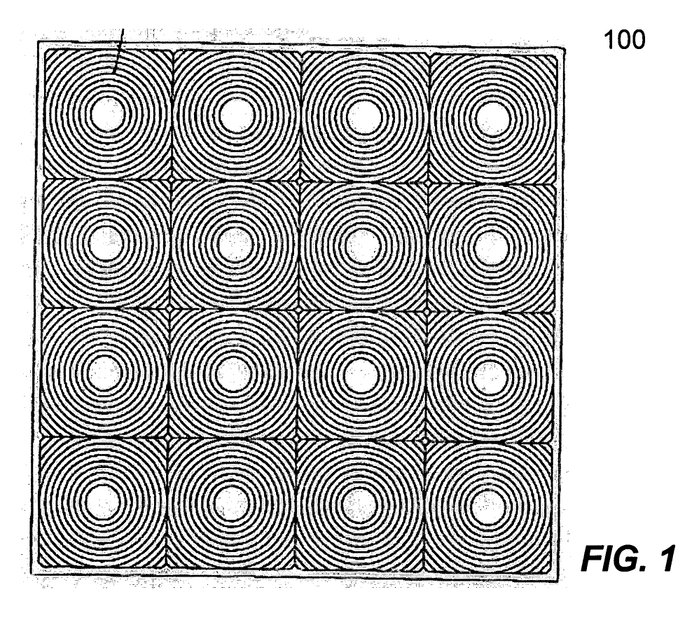

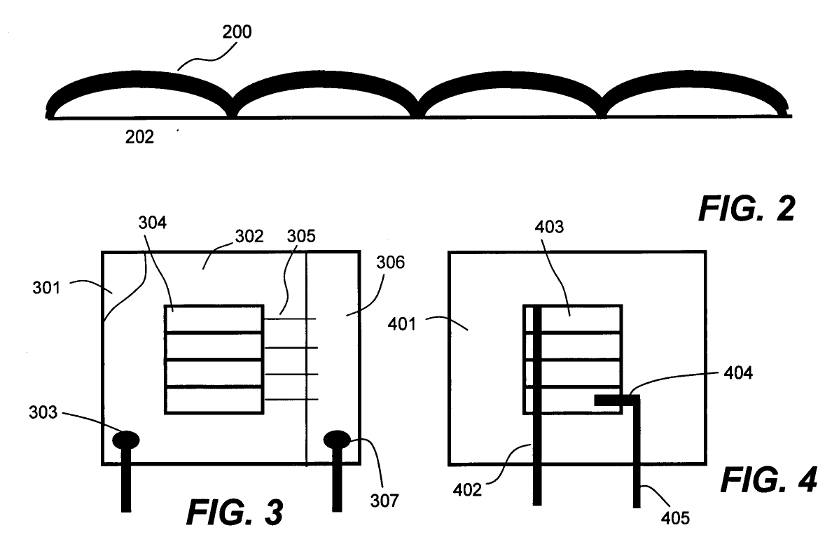

Referring now to the drawings, in which like numerals refer to like parts throughout the several views. FIG. 1 shows a top-view of an array of concentrating lenses 100, each of the lenses 100 is focused on a group of solar cells underneath. According to one embodiment, a lens has a spherical surface 200 as shown in FIG. 2. The internal side of the lens facing the solar cells 202 includes a plurality of concentric V-shaped rings. The lens so designed has been proved that it can concentrate a large amount of sunlight onto a group of solar cells while, at the same time, dissipating heat from the sunlight.

To further reduce heat caused by the focused sunlight, FIG. 3 shows an embodiment of attaching a group of solar cells 304 onto a metallic board 301 coated with a type of anticorrosion material. The larger metallic board 301 facilitates to dissipate heat on the solar cells 304. The solar cells 304 is affixed to the metallic board 301 (e.g., by a type of adhesive). The metallic board 301 also includes an electrode plate 306 that is electrically insulated from the metallic board 301. On the top of the electrode plate 306, there are some metal wires 305 to be connected with the solar cells 304. To output energy signals, the metallic board 301 includes an electrode (or connector) 303, and the electrode plate 306 has another an electrode (or connector) 307.

FIG. 4 shows another embodiment of using a metallic board 401 to facilitate the dissipation of heat on the solar cells 403. The solar cells 403 is affixed to the metallic board 401 (e.g., by a type of adhesive). An electrode 402 is provided on top of the solar cells 403 to connect all of the solar cells 403. Another electrode 405 is provided under the solar cells 403. Depending on the design of the electrode 405 on the end connected to the solar cells 403, the electrode 405 may be simply connected to the substrate of the solar cells 403 or a trough is formed in the metallic board 401 to facilitate the contact between the electrode 405 and the solar cells 403.

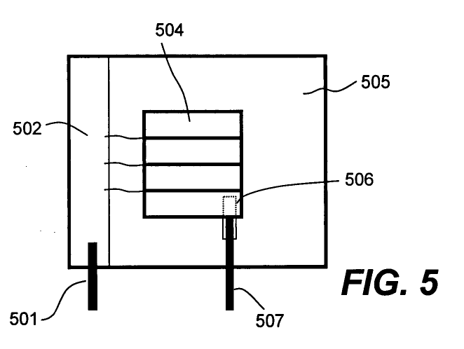

FIG. 5 shows still embodiment of using a metallic board 505 to facilitate the dissipation of heat on the solar cells 504. The solar cells 504 is affixed to the metallic board 505 (e.g., by a type of adhesive). An electrode plate 502 is laid out on or affixed to the side of the metallic board 505. Between every two solar cells, a wire is provided to connect one or two solar cells to the electrode plate 502. The electrode plate 502 is extended by or connected out by an electrode 501. Another electrode 507 is provided under the solar cells 504. Depending on the design of the electrode 507 on the end 506 connected to the solar cells 504, the electrode 507 may be simply connected to the substrate of the solar cells 504 or a trough is formed in the metallic board 505 to facilitate the contact between the electrode end 506 and the solar cells 504.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

1. An apparatus for collecting solar energy, the apparatus comprising:
an array of solar cells; and
an array of concentrating lenses, each positioned above and focusing onto a group of cells, wherein each of the concentrating lenses has a spherical surface that includes a plurality of concentric V-shaped rings to reduce heat being brought to the group of cells.

2. The apparatus as recited in claim 1, wherein the group of cells is affixed onto a metallic board to facilitate dissipation of the heat in the group of cells.

3. The apparatus as recited in claim 2, wherein the metallic board includes an electrode plate that is electrically insulated from the metallic board.

4. The apparatus as recited in claim 2, wherein the cells in the group are respectively coupled to the electrode plate, and wherein the electrode plate is extended by a first connector.

5. The apparatus as recited in claim 4, wherein the metallic board is extended by a second connector.

6. The apparatus as recited in claim 3, wherein the metallic board is coated with a type of anticorrosion material.

7. The apparatus as recited in claim 2, wherein an electrode is provided to connect collectively the solar cells in the group.

8. The apparatus as recited in claim 7, wherein another electrode is provided under the group of solar cells.

9. The apparatus as recited in claim 8, wherein an end of the another electrode is in a trough formed in the metallic board to facilitate a contact between the end of the another electrode and the solar cells.

10. The apparatus as recited in claim 4, wherein an electrode is provided to connect collectively the solar cells in the group.

11. The apparatus as recited in claim 10, wherein another electrode is provided under the group of solar cells.

12. The apparatus as recited in claim 11, wherein an end of the another electrode is in a trough formed in the metallic board to facilitate a contact between the end of the another electrode and the solar cells.

13. An apparatus for collecting solar energy, the apparatus comprising:
an array of solar cells;
an array of concentrating lenses, each positioned above and focusing onto a group of cells, wherein each of the concentrating lenses has a spherical surface that includes a plurality of concentric V-shaped rings to reduce heat being brought to the group of cells,
a metallic board provided to further dissipate heat caused by focused sunlight, wherein the array of solar cells is bonded to the metallic board by a type of adhesive, wherein the adhesive is conductive when an electrode is directly connected to the metallic board, the adhesive is non-conductive when another electrode is provided under the group of solar cells.

14. The apparatus as recited in claim 12, wherein another electrode is provided to connect the solar cells.
